(19) United States
(12) Patent Application Publication
(10) Pub. No.: US 2024/0240886 A1
(43) Pub. Date: Jul. 18, 2024

(54) CONTROL OF HEAT TRANSFER FLUID THROUGH MAGMA-DRIVEN HEAT EXCHANGERS

(71) Applicant: EnhancedGEO Holdings, LLC, St. Petersburg, FL (US)

(72) Inventors: Greg Lindberg, Thonotosassa, FL (US); Kimberly C. Conner, Wetumpka, AL (US)

(21) Appl. No.: 18/116,699

(22) Filed: Mar. 2, 2023

Related U.S. Application Data
(60) Provisional application No. 63/439,810, filed on Jan. 18, 2023.

(51) Int. Cl. F28F 27/00; F24T 10/15

(52) U.S. Cl. CPC F28F 27/00; F24T 10/15; F24T 2010/56

(57) ABSTRACT

Apparatus, system, and method for controlling molten salt heat exchangers. The system includes a magma-driven heat exchanger that extends at least partially into a magma body containing magma. Molten salt flowing through the magma-driven heat exchanger absorbs heat from the magma to form heated molten salt. A second heat exchanger located externally to the magma-driven heat exchanger uses the heated molten salt to heat a working fluid from a first temperature to a second temperature that is higher than the first temperature. The system also includes a set of fluid conduits defining a flow path that conveys the molten salt between the magma-driven heat exchanger and the second heat exchanger in a loop. Fluid control devices are included for controlling flow of the molten salt through the flow path.

### CROSS-REFERENCE TO RELATED APPLICATIONS

This application claims priority to U.S. Provisional Application No. 63/439,810, filed on Jan. 18, 2023, which is hereby incorporated herein by reference in its entirety.

### TECHNICAL FIELD

The present disclosure is related to the field of fluid management, and more particularly to controlling the flow of molten salts through a system that includes magma-driven heat exchangers.

### BACKGROUND

Water is a common heat transfer fluid because it is chemically stable and generally usable across a relatively large temperature range. However, water undergoes a phase change from liquid to gas at sufficiently high temperatures. The liquid form of water has a higher thermal conductivity and higher heat capacity than the gaseous form of water, i.e., steam. At increasingly high temperatures, thicker walls are required to accommodate steam flowing through fluid conduits, containment vessels, and heat exchangers. Thicker walls on heat exchangers reduces the rate of heat transfer.

### SUMMARY

A first embodiment of the present disclosure is directed to a system for controlling flow of molten salt through magma-driven heat exchangers. The system includes a magma-driven heat exchanger that extends at least partially into a magma body containing magma. Molten salt flowing through the magma-driven heat exchanger absorbs heat from the magma to form heated molten salt. A second heat exchanger located externally to the magma-driven heat exchanger uses the heated molten salt to heat a working fluid from a first temperature to a second temperature that is higher than the first temperature. The system also includes a set of fluid conduits defining a flow path that conveys the molten salt between the magma-driven heat exchanger and the second heat exchanger in an endless loop. Fluid control devices are included for controlling flow of the molten salt through the flow path.

A second embodiment of the present disclosure is directed to an apparatus for controlling flow of molten salt through magma-driven heat exchangers. The apparatus includes memory storing instructions and a processor communicatively coupled to the memory. The processor is configured to execute the instructions to obtain first temperature data of heated molten salt conveyed from a magma-driven heat exchanger that extends at least partially into a magma body containing magma. Molten salt flowing through the magma-driven heat exchanger absorbs heat from the magma to form the heated molten salt. The processor is also configured to execute the instructions to obtain second temperature data of cooled molten salt conveyed from a second heat exchanger located externally to the magma-driven heat exchanger. The second heat exchanger converts the heated molten salt to the cooled molten salt by heating a working fluid from a first temperature to a second temperature that is higher than the first temperature. The processor is also configured to execute the instructions to generate control signals for controlling operation of one or more fluid control devices configured to control the flow of the molten salt based on at least one of the first temperature data and the second temperature data.

A third embodiment of the present disclosure is directed to a method for controlling flow of molten salt through magma-driven heat exchangers. The method includes a step of obtaining first temperature data of heated molten salt conveyed from a magma-driven heat exchanger that extends at least partially into a magma body containing magma. Molten salt flowing through the magma-driven heat exchanger absorbs heat from the magma to form the heated molten salt. The method also includes a step of obtaining second temperature data of cooled molten salt conveyed from a second heat exchanger located externally to the magma-driven heat exchanger. The second heat exchanger converts the heated molten salt to the cooled molten salt by heating a working fluid from a first temperature to a second temperature that is higher than the first temperature. The method also includes a step of generating control signals for controlling operation of one or more fluid control devices configured to control a flow rate of the molten salt based on at least one of the first temperature data and the second temperature data.

Other aspects, embodiments and features of the disclosure will become apparent from the following detailed description of the disclosure when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the disclosure shown where illustration is not necessary to allow those of ordinary skill in the art to understand the disclosure.

### BRIEF DESCRIPTION OF THE FIGURES

Features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying figures, wherein:

FIG. 1 is a simplified schematic diagram of a system for controlling flow of molten salt through systems implementing magma-driven heat exchangers according to an illustrative embodiment;

FIG. 2 is another schematic diagram of a system for controlling flow of molten salt through systems implementing magma-driven heat exchangers according to an illustrative embodiment;

FIG. 3 is a schematic diagram of a cross-sectional view of a magma well according to an illustrative embodiment;

FIGS. 4A and 4B are schematic diagrams of the upper and lower portions, respectively, of the magma well of FIG. 3 according to an illustrative embodiment;

FIGS. 5A and 5B are schematic diagrams depicting installation of temperature sensors according to various illustrative embodiments;

FIG. 6 is a schematic diagram of a networked system for controlling flow of molten salt through systems implementing magma-driven heat exchangers according to an illustrative embodiment;

FIG. 7 is schematic diagram of an apparatus for controlling flow of molten salt through systems implementing magma-driven heat exchangers according to an illustrative embodiment; and

FIG. 8 is a flowchart of a process for controlling flow of molten salt through systems implementing magma-driven heat exchangers according to an illustrative embodiment.

### DETAILED DESCRIPTION

Molten salt can be used as a heat transfer fluid for harnessing heat from a source of magma. The heat can then be transferred to a working fluid to allow the working fluid to do work. For example, molten salt heated by a magma-driven heat exchanger can be conveyed through a heat exchanger to heat water to form a working fluid, e.g., steam, that can be used to generate electricity. Alternatively, the heat from the molten salt can be used to drive endothermic reactions. Examples of some types of salts that can be used as molten salts include chlorides, bromides, fluorides, nitrates, and organic salts. Nitrate salts may be used in heat transfer applications due to a low melting point, high operating temperature, low vapor pressure, low toxicity, and low corrosiveness. The nitrate salts can be a eutectic blend of salts such as sodium nitrate and potassium nitrate.

Control of the flow of molten salt through a magma-driven heat exchanger, and thus through a system that includes the magma-driven heat exchanger, is important for a number of reasons. For example, in the absence of flow control, a molten salt can dwell in a magma-driven heat exchanger for an excessive amount of time, leading to breakdown of the molten salt, affecting its thermal properties. Molten salts at excessively high temperatures can also damage system components. On the other hand, molten salts flowing too slowly through fluid conduits of a system for conveying the molten salt may lose too much heat and begin to solidify.

This disclosure recognizes the need for controlling a flow of molten salt through a magma-driven heat exchanger and a system implementing the magma-driven heat exchanger based on multiple inputs of temperature sensors, i.e., temperature data, so that the cooled molten salt entering the magma-driven heat exchanger and the heated molten salt exiting the magma-driven heat exchanger can be measured and used to monitor the steady state and transient magmatic thermal conditions of the system, and to adjust the flow rate of the molten salt using fluid devices, like variable frequency drive (VFD) pumps. The flow rate of the molten salt can be adjusted, for example, to prevent operation at temperatures that can damage system components (e.g., by solidification of the salt at excessively low temperature or by damaging system materials at excessively high temperatures) and/or improve efficiency of system operations (e.g., by providing a molten salt at or near an optimal temperature for a process facilitated by the magma-driven heat exchanger). As such, this disclosure is integrated into the practical application of systems and methods that improve the efficiency and operational lifetime of systems implementing magma-driven heat exchangers. In a non-limiting embodiment, the flow rate of the molten salts are adjusted based on differential temperatures as described in more detail in the disclosure that follows.

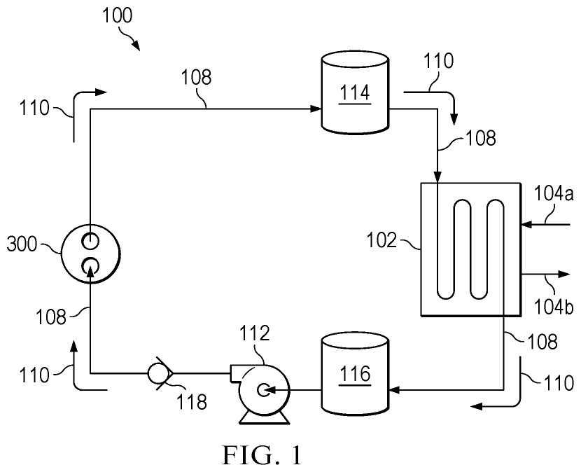

FIG. 1 is a simplified schematic diagram of a system for controlling flow of molten salt through a magma-driven heat exchanger 102 according to an illustrative embodiment. The system 100 is generally configured to harness the heat from magma within a magma chamber or well 300 to heat a molten salt flowing through the system 100. The molten salt can then be used to heat a working fluid from a first temperature to a second temperature that is higher than the first temperature. The heated working fluid can be used to perform work, such as power generation or supplying heat for driving endothermic reactions.

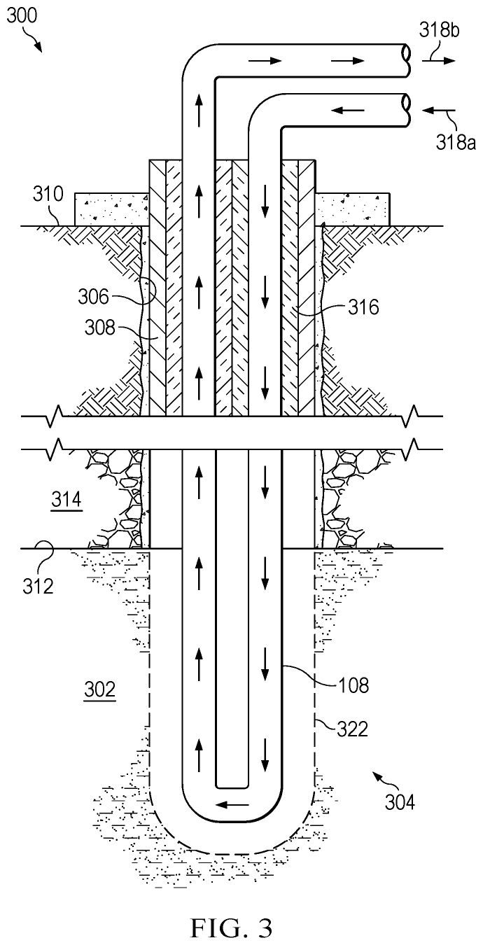

Molten salt can be heated by absorbing heat from a magma well 300 that extends from the surface and at least partially into a magma body containing magma. The heated molten salt can then be conveyed to a heat exchanger 102 located externally to the magma well 300 (see FIG. 3 and corresponding description below). Heat from the molten salt can then be transferred to a working fluid 104 that enters the heat exchanger 102 at a first temperature and exits the heat exchanger 102 at a second temperature that is higher than the first temperature. In a non-limiting embodiment, the working fluid 104 enters the heat exchanger 102 as a fluid condensate 104a, i.e., a liquid state, and can exit the heat exchanger 102 as a working gas 104b, i.e., in a gaseous state. In other embodiments, the flow of molten salt through the system 100 and/or the heat exchanger 102 can be controlled to determine the characteristics of the working fluid exiting the heat exchanger, such as a temperature of the working fluid and/or a state of the working fluid, e.g., liquid state versus gaseous state.

As used herein, and with particular reference to FIG. 3, molten salt 318 leaving the magma well 300 may be referred to in the alternative as “heated molten salt” 318b, which can be differentiated from molten salt entering the magma well 300, which may be referred to in the alternative as “cooled molten salt” 318a. The cooled molten salt 318a conveyed back into the magma well 300 reforms the heated molten salt 318b to continue the process of generating a gaseous working fluid in a continuous process. Accordingly, the magma well 300 may be referred to in the alternative as a magma-driven heat exchanger.

Returning to FIG. 1, the molten salt can be conveyed though the system 100 by a set of fluid conduits 108. As used herein, the term “set” can mean one or more. Thus, a set of fluid conduits can be one or more fluid conduits, such as pipes, connecting various pieces of equipment to allow the molten salt to flow through an endless loop linking the magma well 300 and heat exchanger 102 located externally to the magma well 300. The set of fluid conduits 108 can define a flow path for the molten salt, which is represented by arrows 110, and proceeds in a counter-clockwise direction in system 100.

Control of the flow of molten salt through the system 100 can be achieved by a fluid control device, such as pump 112 that is operatively coupled to the set of fluid conduits 108. The pump 112 can be one or more pumps disposed throughout the system 100 for controlling flow of molten salt through the set of fluid conduits 108 through a variable motor control mechanism, such as a variable frequency drive (VFD) integrated into the pump 112 or operatively coupled with the pump 112. The variable motor control mechanism allows the pump 112 to control the rate of flow of the molten salt through the magma well 300 to control the heat exchange between the magma and the molten salt. A flow rate of molten salt through the magma well 300 that is too quick prevents the molten salt from absorbing enough heat to exchange with the working fluid in the heat exchanger 102, but a flow rate of molten salt that is too slow can cause the molten salt to overheat, which results in degradation of the molten salt and/or possible damage to components of system 100. Degraded molten salt could require evacuation of the degraded molten salt from the system 100 and replenishment of fresh salt, a time intensive and expensive process. During these down times operation of system 100 may not be possible resulting in decreased efficiency. Additionally, molten salt flowing too quickly through heat exchanger 102 may result in inadequate heat exchange with the working fluid 104, whereas molten salt flowing too slowly through the heat exchanger 102 may result in excessive heat exchange with the working fluid 102.

One or more fluid containment vessels can be coupled with the set of fluid conduits 108, i.e., disposed within the flow path 110. In the non-limiting example shown in FIG. 1, the system 100 includes a hot tank 114 and a cold tank 116 for storing heated molten salt 318b and cooled molten salt 318a, respectively (see FIG. 3). Referring to both FIGS. 1 and 3, at least one benefit of the one or more fluid containment vessels is the ability to control the flow rate of the molten salt 318 through discrete portions of the flow path 110. In the absence of the one or more fluid containment vessels, increasing the flow rate of the molten salt 318 through the set of fluid conduits 108 by the pump 112 would result in a proportional increase in the flow rate throughout the entire system 100. For example, if the temperature of the heated molten salt 318b is too high, then the pump 112 can increase the flow rate of the cooled molten salt 318a flowing through the magma well 300 so that the heated molten salt 318b can achieve the desired temperature. The hot tank 114 can accommodate the increased volume of heated molten salt 318b without affecting the flow rate of the heated molten salt 318b through the heat exchanger 102 so that the heat transfer of the working fluid is unaffected by the increased flow rate of cooled molten salt 318a through the magma well 300.

Referring to FIG. 1, one or more check valves can be incorporated throughout system 100 to prevent undesirable back flow of the molten salt 318. In this illustrative embodiment in FIG. 1, a check valve 118 is included in the set of fluid conduits upstream from the magma well 300 to prevent heated molten salt 318b from flowing from the magma well 300 back into the cold tank 116.

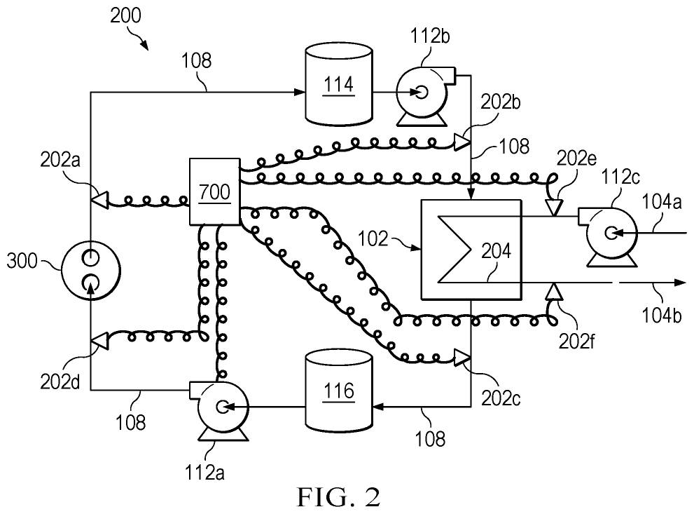

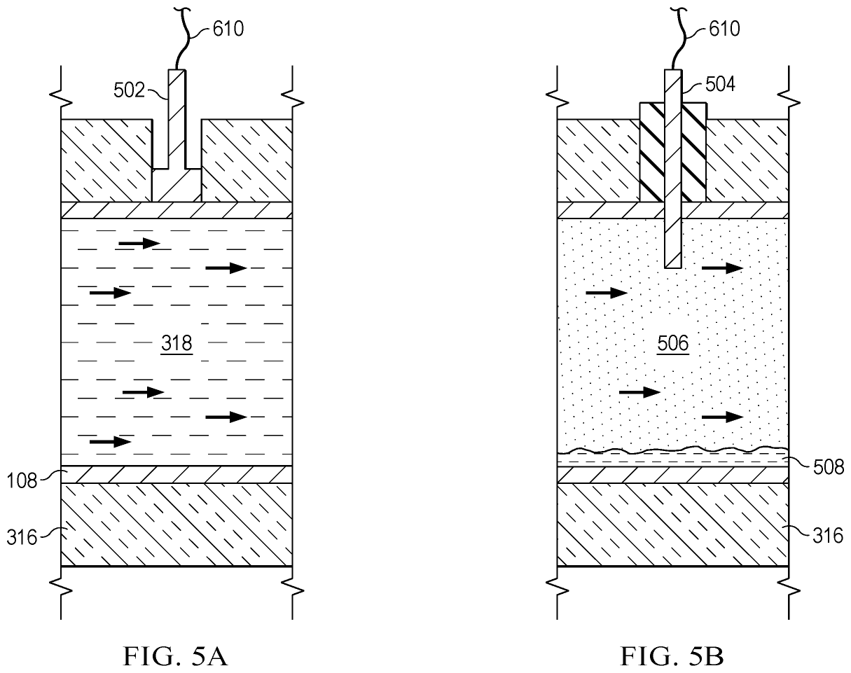

FIG. 2 is schematic diagram of another example system 200 for controlling flow of molten salt 318 through a magma-driven heat exchanger 102 according to an illustrative embodiment. The system 200 is similar to the system 100 depicted in FIG. 1 but includes a set of temperature sensors 202 disposed throughout for gathering temperature data of molten salt 318 flowing through the set of conduits 108 of the system 200, or for gathering temperature data of a working fluid 104 flowing through the set of conduits 204. Non-limiting examples of temperature sensors 202 can include thermal transducers, thermocouples, or probes mounted on the exterior of the set of fluid conduits 108, through the sidewall of the set of fluid conduits 108 and exposed to fluid flow, or a combination of the two. The mounting of examples of temperature sensors 202 is described in more detail below with respect to FIGS. 5A and 5B.

In the example in FIG. 2, the set of temperature sensors 202 includes six temperature sensors 202a, 202b, 202c, 202d, 202e, and 202f. Temperature sensor 202a is placed downstream from the magma well 300 (e.g., proximate an outlet of the magma well 300) to measure a temperature of the heated molten salt 318b leaving the magma well 300. Temperature sensor 202b is placed upstream from the heat exchanger 102 (e.g., proximate an inlet of the heat exchanger 102) to measure a temperature of the heated molten salt 318b before undergoing heat exchange with the working fluid 104. Temperature sensor 202c is placed downstream from the heat exchanger 102 (e.g., proximate an outlet of the heat exchanger 102) to measure a temperature of the cooled molten salt 318a after undergoing heat exchange with the working fluid. Temperature sensor 202d is placed upstream from the magma well 300 (e.g., proximate an inlet of the magma well 300) to measure a temperature of the cooled molten salt 318a before entering the magma well 300. Temperature sensor 202e is coupled to fluid conduit 204 on an inlet side of the heat exchanger 104 (e.g., proximate an inlet of the heat exchanger 102) to measure a temperature of working fluid 104a before entering the heat exchanger 102. Temperature sensor 202f is coupled to fluid conduit 204 on an outlet side of the heat exchanger 104 (e.g., proximate an outlet of the heat exchanger 102) to measure a temperature of working fluid 104b after exiting the heat exchanger 102.

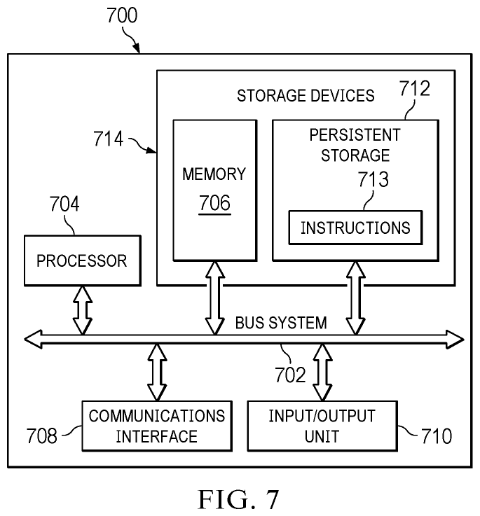

Each of the set of temperature sensors 202 can be coupled to computing device 700 (see FIG. 7), which can use the temperature data gathered by the set of temperature sensors 202 to control the flow rate of molten salt 318 throughout system 200. The computing device 700 can control the flow of the molten salt 318 by generating one or more control signals based on analysis of the temperature data from one or more of the sensors 202 and transmitting the control signals to one or more of the pumps 112a, 112b, and 112c in system 200. For example, one control signal can be based on a temperature differential using measurements taken from temperature sensor 202d and temperature sensor 202a (e.g., the temperature differential across the magma well 300). The control signal can then be sent to the pump 112a for controlling the flow rate of molten salt 318 through the magma well 300. For example, if the difference in temperature between heated molten salt 318b exiting the magma well 300 (measured at sensor 202a) and the cooled molten salt 318a entering the magma well 300 (measured by sensor 202d) is less than a target or threshold value, the control signal may cause pump 112a to decrease a flow rate of molten salt 318a into the magma well 300. This will increase the residence time of molten salt 318 in the magma well 300, such that the heated molten salt 318b will have an increased temperature. Conversely, if the difference in temperature between heated molten salt 318b exiting the magma well 300 (measured at sensor 202a) and the cooled molten salt 318a entering the magma well 300 (measured by sensor 202d) is greater than a target or threshold value, the control signal may cause pump 112a to increase the flow rate of molten salt 318a into the magma well 300, thereby decreasing residence time in magma well 300 and decreasing the temperature of the heated molten salt 318b.

An additional or alternative control signal can be determined based on a temperature differential using measurements taken from temperature sensor 202b and temperature sensor 202c (e.g., the temperature difference of molten salt 318 across the heat exchanger 102). This control signal can be sent to the pump 112b for controlling the flow rate of heated molten salt 318b through the heat exchanger 102. For example, if the difference in temperature between heated molten salt 318b entering the heat exchanger 102 (measured at sensor 202b) and the cooled molten salt 318a exiting the heat exchanger 102 (measured at sensor 202c) is less than a target or threshold value, the control signal may cause pump 112b to decrease a flow rate of molten salt 318b into the heat exchanger 102. This will increase the residence time of molten salt 318b in the heat exchanger 102, such that additional heat exchange can occur to cool the molten salt 318b to form cooled molten salt 318a. Conversely, if the difference in temperature between heated molten salt 318b entering the heat exchanger 102 (measured at sensor 202b) and the cooled molten salt 318a exiting the heat exchanger 102 (measured by sensor 202c) is greater than a target or threshold value, the control signal may cause pump 112b to increase the flow rate of molten salt 318b into the heat exchanger 102, thereby decreasing residence time in heat exchanger 102 and increasing the temperature of the cooled molten salt 318a exiting the heat exchanger 102.

Another additional or alternative control signal can be based on a temperature differential using measurements taken from temperature sensor 202e and 202f (e.g., the temperature difference of working fluid 104 across the heat exchanger 102). This control signal can be sent to the pump 112c for controlling the flow rate of working fluid 104 through the heat exchanger 102. Similarly to the description above for pumps 112a and 112b, a control signal may be provided to pump 112c to adjust the flow rate of working fluid 104a through the heat exchanger 102 in order to achieve, for example, a target temperature difference between working fluid 104a entering the heat exchanger 102 and working fluid 104b exiting the heat exchanger 102.

In some cases, the control signal(s) can be based on a temperature differential based on a temperature setpoint and a measured temperature value. For example, a temperature measured from a sensor 202a-f may be compared to a predefined setpoint value and/or a temperature differential (e.g., as described above) may be compared to a predefined setpoint value in order to determine a control signal for adjusting the flow rates provided by one or more of pumps 112a-c.

The control signals generated by the computing device 700 can be based on or modified by any one or more of the following control approaches: proportional control, integrating control, and derivative response control. Proportional control is a type of linear feedback control system that applies a correction to a control variable. The size of the correction is proportional to an error signal that considers the difference between a setpoint value and a measured value. In a non-limiting embodiment, the setpoint value can be based on a measured temperature, e.g., a temperature differential across the heat exchanger 102, and the control variable can be, for example, pump motor speed or a rate of flow of a molten salt 318. Because the proportional control is based on a difference between a setpoint value and a measure value, offset error is unavoidable. Integrating response control can reduce and/or eliminate the offset error by taking into consideration the amount of time that the offset error has existed. Derivative response control uses the rate of change of the error to produce a dampening signal that minimizes overshoot and oscillation around the setpoint value.

FIG. 3 is a schematic diagram of a cross-sectional view of a magma well 300 according to an illustrative embodiment. The magma well 300 is configured to operate as a heat exchanger where magma 302 in a magma body 304 serves as a source of heat for heating molten salt 318 conveyed through the magma well 300.

The magma well 300 is formed from a borehole 306 extending from the surface 310 and at least partially into a magma body 304 containing magma 302. The borehole 306, which can be partially or completely cased with a casing 308, extends from the surface 310 and through the magma ceiling 312 separating the rock layer 314 and into the magma body 304 storing the magma 302.

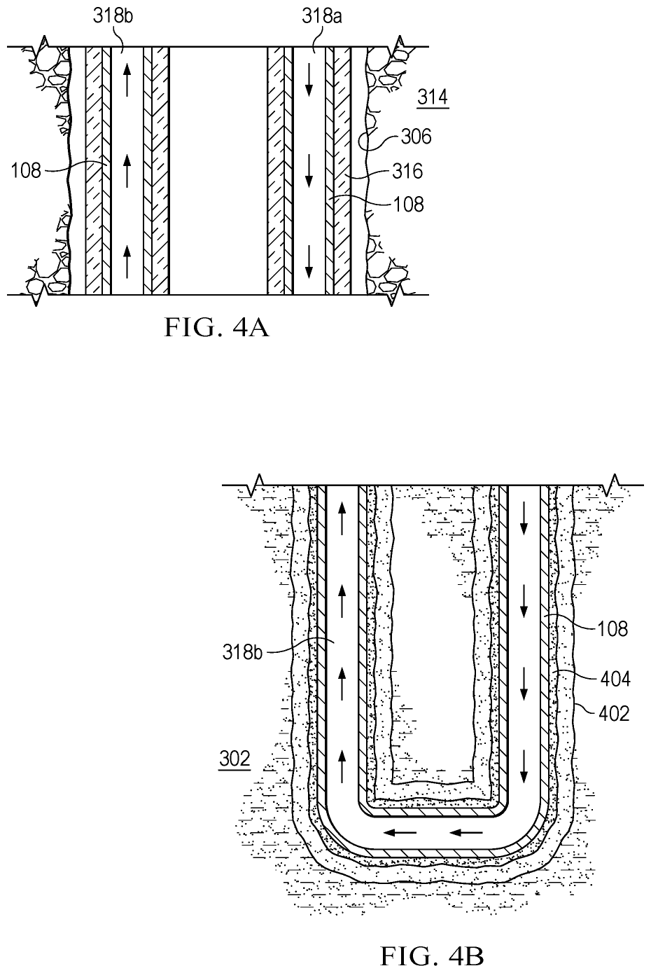

Housed within the magma well 300 is a length of pipe, e.g., a segment of fluid conduit 108, which is at least partially submerged in magma 302. Portions of the fluid conduit 108 passing through the rock layer 314 can be wrapped in insulation 316 to reduce undesirable heat loss/transfer from the molten salt 318 passing therethrough. A more detailed view of the upper portion of the magma well 300 is provided in FIG. 4A that follows. Although not depicted in FIG. 3, portions of the fluid conduit 108 outside of the magma well 300 can also be wrapped in an insulation layer, as shown in FIG. 5A.

During operation of the magma well 300, cooled molten salt 318a enters the magma well 300 and travels downwardly from the surface 310 toward the magma body 304 and absorbs heat from the magma 302 to form heated molten salt 318b. Heated molten salt 318b can be removed from the magma well 300 and conveyed through a system, such as system 100 or system 200. The system can utilize the heated molten salt 318b as previously described above. Although the heat exchange in the magma well 300 is shown to take place through a segment of the fluid conduit 108 submerged within the magma 302, in another embodiment, the heat exchange can take place instead in a vessel submerged that is at least partially submerged in the magma 302 and is fluidically coupled with the set of fluid conduits 108 to allow cooled molten salt 318a to enter the vessel and heated molten salt 318b to exit the vessel.

The magma well 300 may be prepared using any appropriate method. For example, during drilling of the borehole 306, a sufficient quantity of a drilling fluid with desirable thermodynamic properties can cause the magma 302 ahead of the drill bit to solidify, allowing the drill bit to drill the borehole 306 into the magma body 304 until a desired depth has been achieved. The solidified magma 302 can be maintained by a continued inflow of the drilling fluid into the borehole 306. A length of fluid conduit 108 can be installed in the borehole 306 while the borehole 306 is in solidified form, i.e., either while drilling fluid is maintained within the borehole 306, or shortly after the drilling fluid has been withdrawn. Over time the sidewalls of the borehole 306 within the magma body 304 will re-melt and reform around the external sidewalls of the segment of the fluid conduit 108 suspended within the magma body 304. Thus, the borehole 306 will collapse from its drilled configuration, represented by dashed line 322, allowing magma 302 to solidify against the fluid conduit 108. A more detailed view of the layered rock re-formed around the fluid conduit 108 is shown in FIG. 4B that follows.

FIGS. 4A and 4B are schematic diagrams of the upper and lower portions, respectively, of the magma well 300 according to an illustrative embodiment. With particular reference to FIG. 4A, cooled molten salt 318a flows in a downwardly direction in a fluid conduit 108 housed within a borehole 306 that extends from the surface through a rock layer 314. The fluid conduit 108 is shown wrapped in an insulation layer 316 to reduce heat loss/transfer. The heated molten salt 318b is returned to the surface via the fluid conduit 108, which passes through the rock layer 314.

FIG. 4B depicts the formation of layered rock around the fluid conduit 108 after the borehole 306 collapses. In particular, the magma 302 may melt the sidewalls of the borehole 306, causing the magma 302 to contact the exterior surface of the fluid conduit 108. The heat transfer from the magma 302 to the molten salt 318 flowing through the fluid conduit 108 may cause the magma 302 to solidify against the fluid conduit 108 and form a solidus rock layer 402. The solidus rock layer 402 may be separated from the magma 302 by a plastic rock layer 404.

FIGS. 5A and 5B are schematic diagrams depicting installation of temperature sensors according to various illustrative embodiments. The temperature sensors 502 and 504 in FIG. 5 may be used as temperature sensors 202 shown in FIG. 2, which are configured to measure the temperature of fluids flowing through fluid conduits 108. In particular, FIG. 5A depicts a surface temperature sensor 502 that can be coupled to the exterior surface of fluid conduit 108 to gather temperature data usable to calculate a temperature of the molten salt 318 flowing through the depicted segment of the fluid conduit 108. A computing device can calculate the temperature of the molten salt 318 based on the temperature at the surface of the fluid conduit 108 and a thermal conductivity of the fluid conduit 108.

FIG. 5B depicts an immersion temperature sensor 504 that passes through the sidewall of a fluid conduit to measure a temperature of fluid flowing through the fluid conduit. In a non-limiting example, the immersion temperature sensor 504 is used to measure the temperature of a gaseous fluid, such as steam 506 or other gaseous working fluid. The immersion temperature sensor 504 may also be usable to measure the temperature of a liquid that does not exceed the operating temperatures of immersion temperature sensor 504, such as a condensed working fluid 508. For example, the immersion temperature sensor 504 can be used to measure the temperature of the working fluid condensate 104a entering the heat exchanger 102 and/or the working gas 104b exiting the heat exchanger 102. Temperature data obtained by the measurements of these temperature sensors 502, 504 can be used by a computing device, such as computing device 700, to control a pump that controls the flow rate of working fluid through the heat exchanger 102, i.e., a slower flow rate to increase an amount of heat transfer or a faster flow rate to decrease the amount of heat transfer, or to control pumps 112 that control a flow rate of the molten salt 318 in a manner that could alter the amount of heat transfer with the working fluid.

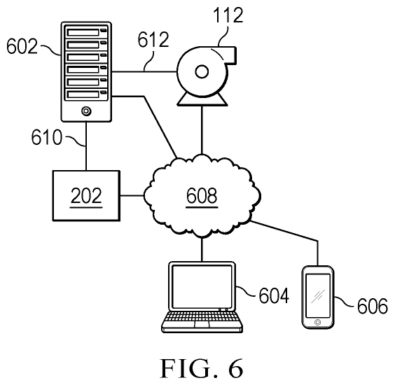

FIG. 6 is a schematic diagram of a networked system for controlling flow of molten salt through systems implementing magma-driven heat exchangers according to an illustrative embodiment. The system 600 includes a plurality of computing devices 602, 604, and 606. Examples of computing devices 602, 604, and 606 can include servers, desktop computers, laptop computers, tablets, cell phones, or any other form of computing device. Generally, one or more of the computing devices can be used to send and receive data for controlling the flow of molten salt through a system that includes a magma-driven heat exchanger.

In a non-limiting example, computing device 602 can be a server that receives temperature data from a set of temperature sensors 202 and generates control signals for transmission to a set of pumps 112 controlling the flow of molten salt 318. In some embodiments, the computing device 602 can receive temperature data directly from the set of temperature sensors 202 via direct communications link 610 and can transmit the control signals directly to the set of pumps 112 via direct communications link 612. The direct communications links 610 and 612 can be hardwired communications links or a wireless communications link implementing device-to-device communications protocols. In another embodiment, the temperature data can be transmitted from the set of temperature sensors 202 to the computing device 602 via the network 608 and the control signals can be transmitted from the computing device 602 to the set of pumps 112 via the network 608. The network 608 can include the internet, the Public Switched Telephone Network (PSTN), cellular networks, and local area networks, among others.

Operators of computing device 604 and/or 606 can receive system alerts and can monitor the operation of computing device 602, temperature data gathered by the set of temperature sensors 202, or the operating parameters of the set of pumps 112. In some embodiments, override commands can be generated on one of the computing devices 604 or 606 for controlling the flow of molten salts.

FIG. 7 is schematic diagram of an apparatus for controlling flow of molten salt through systems implementing magma-driven heat exchangers according to an illustrative embodiment. The apparatus 700 can be a computing device, such as computing device 602 in FIG. 6. The apparatus 700 includes a bus system 702 that supports communication between at least one processor 704, at least one storage device 714, at least one communications interface 708, and at least one input/output (I/O) unit 710.

The memory 706 and a persistent storage 712 are examples of storage devices 714, which represent any structure(s) capable of storing and facilitating retrieval of information (such as data, program code, and/or other suitable information on a temporary or permanent basis). The memory 706 may represent a random-access memory or any other suitable volatile or non-volatile storage device(s). The persistent storage 712 may contain one or more components or devices supporting longer-term storage of data, such as a read only memory, hard drive, Flash memory, or optical disc.

The processor 704 may execute instructions 713 that may be stored in persistent storage 712 and loaded into the memory 706. The processor 704 may include any suitable number(s) and type(s) of processors or other devices in any suitable arrangement. Example types of processors 704 include microprocessors, microcontrollers, digital signal processors, field programmable gate arrays, application specific integrated circuits, and discreet circuitry.

The communications interface 708 may support communications with other systems or devices. For example, the communications interface 708 could include a network interface card or a wireless transceiver facilitating communications over the network 608. The communications interface 708 may support communications through any suitable physical or wireless communication link(s). The communications interface 708 can allow the apparatus 700 to communicate with temperature sensors 202 and pumps 112, either directly via device-to-device communications protocols, or through network 608.

The I/O unit 710 may allow for input and output of data. For example, the I/O unit 710 may provide a connection for user input through a keyboard, mouse, keypad, touchscreen, or other suitable input device. The I/O unit 710 may also send output to a display, printer, or other suitable output device.

As described herein, the apparatus 700 can be used to control fluid flow of molten salt through a system, such as system 100 or system 200 based on temperature data obtained from temperature sensors 202. The apparatus 700 can generate control signals based on the temperature data for transmission to pumps 112, which can be used to control the fluid flow of the molten salt.

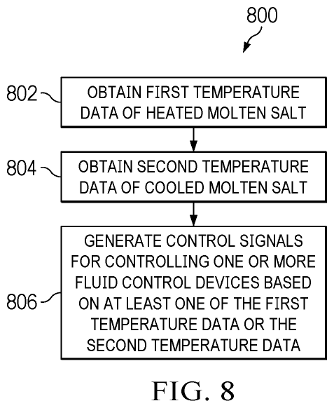

FIG. 8 is a flowchart of a process for controlling flow of molten salt through systems implementing magma-driven heat exchangers according to an illustrative embodiment. Flowchart 800 can be implemented in a computing device, such as computing device 602 or computing device 700.

Flowchart 800 begins at step 802 by obtaining a first temperature data of heated molten salt conveyed from a magma-driven heat exchanger that extends at least partially into a magma body containing magma. Molten salt flowing through the magma-driven heat exchanger absorbs heat from the magma to form the heated molten salt. For example, temperature data from sensors 202a and/or 202b of FIG. 2 may be used to determine a temperature of the heated molten salt 318b.

In step 804, second temperature data of cooled molten salt conveyed from a second heat exchanger located externally to the magma-driven heat exchanger is obtained. The second heat exchanger converts the heated molten salt to the cooled molten salt by heating a working fluid from a first temperature to a second temperature that is higher than the first temperature. For example, temperature data from sensors 202c and/or 202d of FIG. 2 may be used to determine a temperature of the cooled molten salt 318a.

In step 806, control signals are generated for controlling one or more fluid control devices based on at least one of the first temperature data or the second temperature data. The control signals can be generated by using one or more of a proportional control approach, an integrating control approach, and derivative response control approach. Examples of controls signals that may be generated and transmitted to pumps 112a-c are described above with respect to the example of FIG. 2.

### Additional Embodiments

The following descriptive embodiments are offered in further support of the one or more aspects of this disclosure.

In a first embodiment, aspects of the present disclosure are directed to a system for controlling flow of molten salt through magma-driven heat exchangers. The system includes a magma-driven heat exchanger that extends at least partially into a magma body containing magma. Molten salt flowing through the magma-driven heat exchanger absorbs heat from the magma to form heated molten salt. A second heat exchanger located externally to the magma-driven heat exchanger uses the heated molten salt to heat a working fluid from a first temperature to a second temperature that is higher than the first temperature. The system also includes a set of fluid conduits defining a flow path that conveys the molten salt between the magma-driven heat exchanger and the second heat exchanger in a loop. Fluid control devices are included that are configured to control flow of the molten salt through the flow path.

In another aspect of the first embodiment, the fluid control devices includes a set of pumps operably connected with the set of fluid conduits. The set of pumps are configured to control a flow rate of the molten salt along the flow path. The system further comprises a set of temperature sensors coupled to the set of fluid conduits. The set of temperature sensors are configured to determine temperature of the molten salt at predetermined locations along the flow path, and a computing device operably connected to the set of pumps and the set of temperature sensors, wherein the computing device controls operation of the set of pumps based on temperature data obtained by the set of temperature sensors.

In another aspect of the first embodiment, the computing device further comprises memory storing instructions and a processor communicatively coupled to the memory. The processor executes the instructions to determine a first temperature of the heated molten salt at a first flow position and a second temperature of the cooled molten salt at a second flow position, and generate control signals for controlling the set of pumps based on a temperature differential based on at least one of the first temperature and the second temperature.

In another aspect of the first embodiment, the control signals are generated using at least one of a proportional response approach based on a deviation from a temperature set point and the temperature differential, an integrating response approach based on a length of time of the deviation from the temperature set point, and a derivative response approach that reduces oscillation around the set point based on a rate of change of the deviation from the temperature set point.

In another aspect of the first embodiment, at least one temperature sensor in the set of temperature sensors are coupled to an exterior surface of the set of fluid conduits.

In another aspect of the first embodiment, the system includes a second set of fluid conduits conveying the molten salt to and from the second heat exchanger; a second set of temperature sensors coupled to the second set of fluid conduits; and a second set of pumps operably connected to the second set of fluid conduits, wherein the computing device controls the second set of pumps based on temperature data from the second set of temperature sensors, and the second set of temperature sensors extend into the second set of fluid conduits to contact the molten salt therein.

In another aspect of the first embodiment, the system includes a hot tank disposed in the flow path which receives heated molten salt from the magma-driven heat exchanger, and a cold tank disposed in the flow path which receives cooled molten salt from the second heat exchanger.

In another aspect of the first embodiment, the system includes a third set of fluid conduits conveying the working fluid to and from the second heat exchanger. The system also includes a third set of temperature sensors coupled to the third set of fluid conduits. The system also includes a third set of pumps operably connected to the third set of fluid conduits, wherein the computing device controls the third set of pumps based on temperature data from the third set of temperature sensors.

In a second embodiment, aspects of the present disclosure are directed to an apparatus for controlling flow of molten salt through magma-driven heat exchangers. The apparatus includes memory storing instructions and a processor communicatively coupled to the memory. The processor is configured to execute the instructions to obtain first temperature data of heated molten salt conveyed from a magma-driven heat exchanger that extends at least partially into a magma body containing magma. Molten salt flowing through the magma-driven heat exchanger absorbs heat from the magma to form the heated molten salt. The processor is also configured to execute the instructions to obtain second temperature data of cooled molten salt conveyed from a second heat exchanger located externally to the magma-driven heat exchanger. The second heat exchanger converts the heated molten salt to the cooled molten salt by heating a working fluid from a first temperature to a second temperature that is higher than the first temperature. The processor is also configured to execute the instructions to generate control signals for controlling operation of one or more fluid control devices configured to control the flow of the molten salt based on at least one of the first temperature data and the second temperature data.

In another aspect of the second embodiment, the first temperature data is measured by a first temperature sensor disposed on an exterior surface of a fluid conduit conveying the heated molten salt from the magma-driven heat exchanger, and the second temperature data is measured by a second temperature sensor disposed on an exterior surface of a fluid conduit conveying the cooled molten salt to the magma-driven heat exchanger.

In another aspect of the second embodiment, the one or more fluid control devices includes at least one pump.

In another aspect of the second embodiment, the at least one pump is a variable frequency drive pump.

In another aspect of the second embodiment, the apparatus further comprises a communications interface communicatively coupled to the first temperature sensor, the second temperature sensor, and the at least one pump.

In another aspect of the second embodiment, the processor executes the instructions to generate control signals using at least one of a proportional control approach, an integrating control approach, and derivative response control approach.

In another aspect of the second embodiment, the processor executes the instructions to: obtain temperature data of working fluid flowing through the second heat exchanger; and generate secondary control signals for controlling a flow rate of the working fluid through the second heat exchanger, wherein the secondary control signals are transmitted to one or more fluid control devices coupled to fluid conduits carrying the working fluid.

In a third embodiment, aspects of the present disclosure are directed to a method for controlling flow of molten salt through magma-driven heat exchangers. The method includes a step of obtaining first temperature data of heated molten salt conveyed from a magma-driven heat exchanger that extends at least partially into a magma body containing magma. Molten salt flowing through the magma-driven heat exchanger absorbs heat from the magma to form the heated molten salt. The method also includes a step of obtaining second temperature data of cooled molten salt conveyed from a second heat exchanger located externally to the magma-driven heat exchanger. The second heat exchanger converts the heated molten salt to the cooled molten salt by heating a working fluid from a first temperature to a second temperature that is higher than the first temperature. The method also includes a step of generating control signals for controlling operation of one or more fluid control devices configured to control a flow rate of the molten salt based on at least one of the first temperature data and the second temperature data.

In another aspect of the third embodiment, the first temperature data and the second temperature data are received from temperature sensors disposed on an exterior surface of a fluid conduit through which the heated molten salt or the cooled molten salt flows.

In another aspect of the third embodiment, the control signals are generated using at least one of a proportional response approach based on a deviation from a temperature set point and the temperature differential, an integrating response approach based on a length of time of the deviation from the temperature set point, and a derivative response approach that reduces oscillation around the set point based on a rate of change of the deviation from the temperature set point.

In another aspect of the third embodiment, the control signals cause the one or more fluid control devices to modify the flow rate of the molten salt based on a temperature differential across the magma-driven heat exchanger or the second heat exchanger.

In another aspect of the third embodiment, the control signals cause the one or more fluid control devices to modify the flow rate of the molten salt based on deviation of a measured temperature from a setpoint temperature.

In another aspect of the third embodiment, the control signals cause the one or more fluid control devices to only modify the flow rate of the molten salt through the magma-driven heat exchanger or the second heat exchanger.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred embodiments, it will be understood by those skilled in the art that various changes in form and detail may be made therein without departing from the spirit and scope of the disclosure. The inventors expect skilled artisans to employ such variations as appropriate, and the inventors intend the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for controlling flow of molten salt through magma-driven heat exchangers, the system comprising:
a magma-driven heat exchanger that extends at least partially into a magma body containing magma, wherein molten salt flowing through the magma-driven heat exchanger absorbs heat from the magma to form heated molten salt;
a second heat exchanger located externally to the magma-driven heat exchanger, wherein the second heat exchanger uses the heated molten salt to heat a working fluid from a first temperature to a second temperature that is higher than the first temperature;
a set of fluid conduits defining a flow path that conveys the molten salt between the magma-driven heat exchanger and the second heat exchanger in a loop;
a first fluid pump operably connected with the set of fluid conduits and configured to control flow of the molten salt through the magma-driven heat exchanger; and
a second fluid pump operably connected with the set of fluid conduits and configured to control flow of the molten salt through the second heat exchanger.

2. The system of claim 1, wherein the system further comprises:
a set of temperature sensors coupled to the set of fluid conduits, the set of temperature sensors configured to determine temperature of the molten salt at predetermined locations along the flow path; and
a computer operably connected to the first fluid pump, the second fluid pump, and the set of temperature sensors, wherein the computer is configured to control operation of the first fluid pump and the second fluid pump based on temperature data obtained by the set of temperature sensors.

3. The system of claim 2, wherein the computer further comprises:
memory storing instructions; and
a processor communicatively coupled to the memory, wherein the processor executes the instructions to:
determine a first temperature of the heated molten salt at a first flow position and a second temperature of the cooled molten salt at a second flow position; and
generate control signals for controlling the first fluid pump and the second fluid pump based on a temperature differential based on at least one of the first temperature and the second temperature.

4. The system of claim 3, wherein the control signals are generated using at least one of a proportional response approach based on a deviation from a temperature set point and the temperature differential, an integrating response approach based on a length of time of the deviation from the temperature set point, and a derivative response approach that reduces oscillation around the set point based on a rate of change of the deviation from the temperature set point.

5. The system of claim 2, wherein at least one temperature sensor in the set of temperature sensors is coupled to an exterior surface of the set of fluid conduits.

6. The system of claim 2, wherein;
the set of fluid conduits comprises conduits conveying the molten salt to and from the second heat exchanger;
the set of temperature sensors comprises a first pair of temperature sensors coupled to the conduits conveying the molten salt to and from the second heat exchanger; and
the second fluid pump is operably connected to the conduits conveying the molten salt to and from the second heat exchanger, wherein:
the computer controls the second fluid pump based on temperature data from the first pair of temperature sensors, and
the first pair of temperature sensors extend into the conduits conveying the molten salt to and from the second heat exchanger to contact the molten salt therein.

7. The system of claim 1, further comprising:
a hot tank disposed in the flow path which receives heated molten salt from the magma-driven heat exchanger, wherein flow of the heated molten salt from the hot tank toward the second heat exchanger is facilitated by the second fluid pump; and
a cold tank disposed in the flow path which receives cooled molten salt from the second heat exchanger, wherein flow of the cooled molten salt from the cold tank toward the magma-driven heat exchanger is facilitated by the first fluid pump.

8. The system of claim 6, wherein:
the system further comprises a second set of fluid conduits conveying the working fluid to and from the second heat exchanger;
the set of temperature sensors comprises a second pair of temperature sensors coupled to the second set of fluid conduits; and
the system further comprises a third fluid pump operably connected to the second set of fluid conduits, wherein the computer controls the third fluid pump based on temperature data from the second pair of temperature sensors.

9. An apparatus for controlling flow of molten salt through magma-driven heat exchangers, the apparatus comprising:
memory storing instructions;
a processor communicatively coupled to the memory and configured to execute the instructions to:
obtain first temperature data of heated molten salt conveyed from a magma-driven heat exchanger that extends at least partially into a magma body containing magma, wherein molten salt flowing through the magma-driven heat exchanger absorbs heat from the magma to form the heated molten salt;
obtain second temperature data of cooled molten salt conveyed from a second heat exchanger located externally to the magma-driven heat exchanger, wherein the second heat exchanger converts the heated molten salt to the cooled molten salt by heating a working fluid from a first temperature to a second temperature that is higher than the first temperature; and
generate control signals configured to control operation of one or more fluid control devices configured to control a flow rate of the molten salt based on at least one of the first temperature data and the second temperature data.

10. The apparatus of claim 9, wherein the first temperature data is measured by a first temperature sensor disposed on an exterior surface of a fluid conduit conveying the heated molten salt from the magma-driven heat exchanger, and wherein the second temperature data is measured by a second temperature sensor disposed on an exterior surface of a fluid conduit conveying the cooled molten salt to the magma-driven heat exchanger.

11. The apparatus of claim 9, wherein the one or more fluid control devices includes at least one pump.

12. The apparatus of claim 11, wherein the apparatus further comprises a communications interface communicatively coupled to the first temperature sensor, the second temperature sensor, and the at least one pump.

13. The apparatus of claim 9, wherein the processor executes the instructions to generate control signals using at least one of a proportional control approach, an integrating control approach, and derivative response control approach.

14. The apparatus of claim 9, wherein the processor executes the instructions to:
obtain temperature data of working fluid flowing through the second heat exchanger; and
generate secondary control signals for controlling a flow rate of the working fluid through the second heat exchanger, wherein the secondary control signals are transmitted to one or more fluid control devices coupled to fluid conduits carrying the working fluid.

15. A method of controlling flow of molten salt through magma-driven heat exchangers, the method comprising:
obtaining first temperature data of heated molten salt conveyed from a magma-driven heat exchanger that extends at least partially into a magma body containing magma, wherein molten salt flowing through the magma-driven heat exchanger absorbs heat from the magma to form the heated molten salt;
obtaining second temperature data of cooled molten salt conveyed from a second heat exchanger located externally to the magma-driven heat exchanger, wherein the second heat exchanger converts the heated molten salt to the cooled molten salt by heating a working fluid from a first temperature to a second temperature that is higher than the first temperature; and
generating control signals for controlling operation of one or more fluid control devices configured to control a flow rate of the molten salt based on at least one of the first temperature data and the second temperature data.

16. The method of claim 15, wherein the first temperature data and the second temperature data are received from temperature sensors disposed on an exterior surface of a fluid conduit through which the heated molten salt or the cooled molten salt flows.

17. The method of claim 15, wherein the control signals are generated using at least one of a proportional response approach based on a deviation from a temperature set point and the temperature differential, an integrating response approach based on a length of time of the deviation from the temperature set point, and a derivative response approach that reduces oscillation around the set point based on a rate of change of the deviation from the temperature set point.

18. The method of claim 15, wherein the control signals cause the one or more fluid control devices to modify the flow rate of the molten salt based on a temperature differential across the magma-driven heat exchanger or the second heat exchanger.

19. The method of claim 15, wherein the control signals cause the one or more fluid control devices to modify the flow rate of the molten salt based on deviation of a measured temperature from a setpoint temperature.

20. The method of claim 15, wherein the control signals cause the one or more fluid control devices to only modify the flow rate of the molten salt through the magma-driven heat exchanger or the second heat exchanger.
